(19) United States
(12) Patent Application Publication
(10) Pub. No.: US 2017/0020783 A1
(43) Pub. Date: Jan. 26, 2017

(54) Delivery of Medicine or Other Therapy Orally

(71) Applicant: JSIP, LLC, Waban, MA (US)

(72) Inventors: Nissim Shani, Waban, MA (US); Nissim Israeli, Ranana (IL); Yuval Israeli, Ranana (IL)

(21) Appl. No.: 14/828,091

(22) Filed: Aug. 17, 2015

Related U.S. Application Data
(63) Continuation-in-part of application No. 14/803,959, filed on Jul. 20, 2015.

(51) Int. Cl. A61J 1/14; B65D 43/02; B65D 25/38

(52) U.S. Cl. CPC A61J 1/1412; B65D 25/38; B65D 43/02

(57) ABSTRACT

Among other things, a container has a chamber and an open end of the chamber. The container is configured at the open end to be surrounded by lips of a user to permit the user to apply suction to the chamber through the open end. A gelled dose of a therapeutic agent in the chamber is in contact with a wall of the chamber and is between the wall of the chamber and the open end. There is at least one hole in the wall for air to reach the gelled dose when the user is applying the suction to the chamber to release the gelled dose into the user's mouth. A mechanism prevents contamination of the gelled dose through the hole in the wall until the user is ready to consume the gelled dose and permits air to reach the gelled dose through the holes when the user is ready to consume the gelled dose.

This application is a continuation in part of and is entitled to the benefit of the filing date of U.S. patent application Ser. No. 14/803,959, filed Jul. 20, 2015, the entire contents of which are incorporated here by reference.

### BACKGROUND

This description relates to delivery of medicine or other therapy orally.

A typical way to deliver therapy orally is to put the therapeutic agent in liquid form into a cup, can, bottle, or other container and have the user drink the therapeutic agent (for example, medicine, health supplement, an energy drink, or other liquid, or any combination of them) from the container.

It is also known to deliver, for amusement, for example, a “shot” of alcohol-spiked gelatin served in a small plastic shot glass from which the gelatin can be scooped out of the shot glass using a utensil or a finger and then put into a user's mouth. Another way to get the shot into the mouth uses a so-called suck and blow tube that contains the shot. One person blows into one open end of the tube while another person sucks on the other open end of the tube to transfer the shot into his mouth.

### SUMMARY

In general, in an aspect, a container has a chamber and an open end of the chamber. The container is configured at the open end to be surrounded by lips of a user to permit the user to apply suction to the chamber through the open end. A gelled dose of a therapeutic agent in the chamber is in contact with a wall of the chamber and is between the wall of the chamber and the open end. There is at least one hole in the wall for air to reach the gelled dose when the user is applying the suction to the chamber to release the gelled dose into the user's mouth. A mechanism prevents contamination of the gelled dose through the hole in the wall until the user is ready to consume the gelled dose and permits air to reach the gelled dose through the holes when the user is ready to consume the gelled dose.

Implementations may include one or a combination of any two or more of the following features. The container includes two elements that define an air passage from the outside world to the hole in the wall. The air passage is unconnected to the chamber except through the hole in the wall.

The two elements of the container are concentric. The air passage includes an annular passage between the two concentric elements. The air passage includes a tube adjacent to the chamber. The mechanism includes a breakable seal. The mechanism includes a lid that covers the open end of the container. The hole in the wall includes a conical vent. The mechanism permits the two elements to be moved relative to one another when the user is ready to consume the gelled dose. The mechanism permits the two elements to be moved axially relative to one another when the user is ready to consume the gelled dose. The mechanism includes a lid the removal of which permits air to reach the holes in the wall. The air passage extends from an intake that is closer to the open end of the container than it is to the holes in the wall. The mechanism includes devices on the two elements of the container that cause the air passage to be opened when one of the elements of the container is twisted relative to the other element of the container.

In general, in an aspect, a person who is consuming a dose of a therapeutic agent that has been pre-marked by a manufacturer with a scannable code is enabled to scan and store the code on a mobile device. The person is also enabled to input information into the mobile device that relates to the dose, its use, or the person, or a combination of any two or more of them. Information associated with the scanned code and the information input by the person are caused to be transmitted through a communication network to a data store.

These and other aspects, features, and implementations and combinations of them can be expressed as methods, apparatus, systems, components, means for performing activities, software, program products, databases, methods of doing business, and in other ways.

These and other aspects, features, implementations, and advantages will become apparent from the following description and claims.

### DESCRIPTION

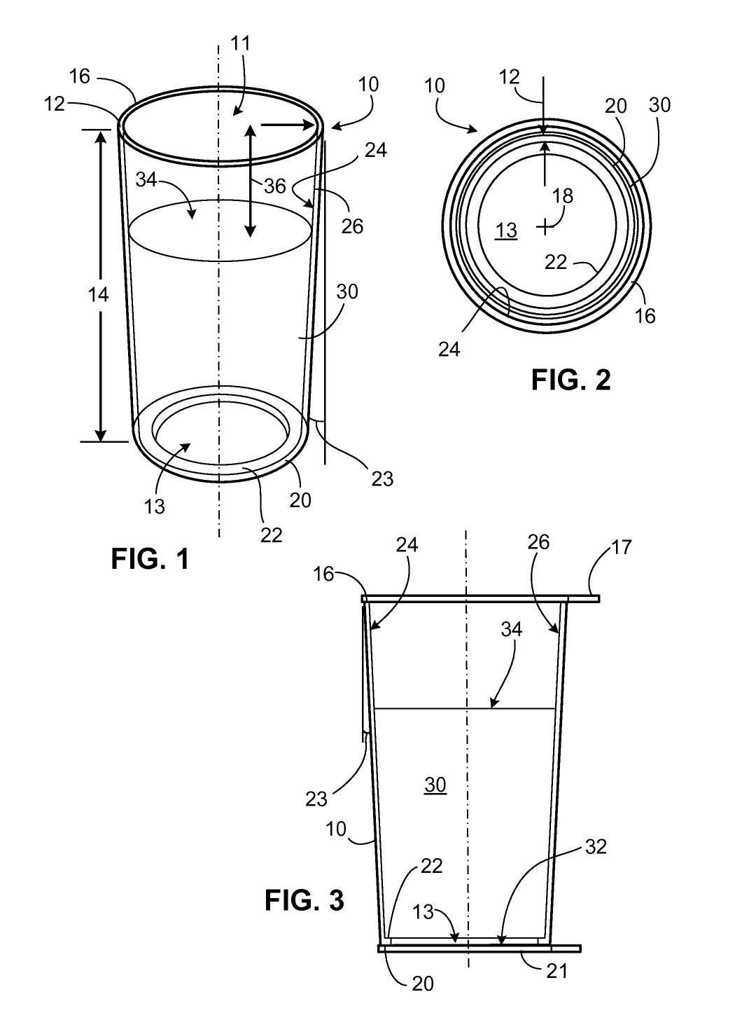

FIG. 1 is a side perspective view of a container with a quantity of a therapeutic agent.

FIG. 2 is a bottom view of a container with a quantity of a therapeutic agent.

FIG. 3 is a side view of a container with the quantity of a therapeutic agent.

FIG. 4 is a perspective view of a bottom cover.

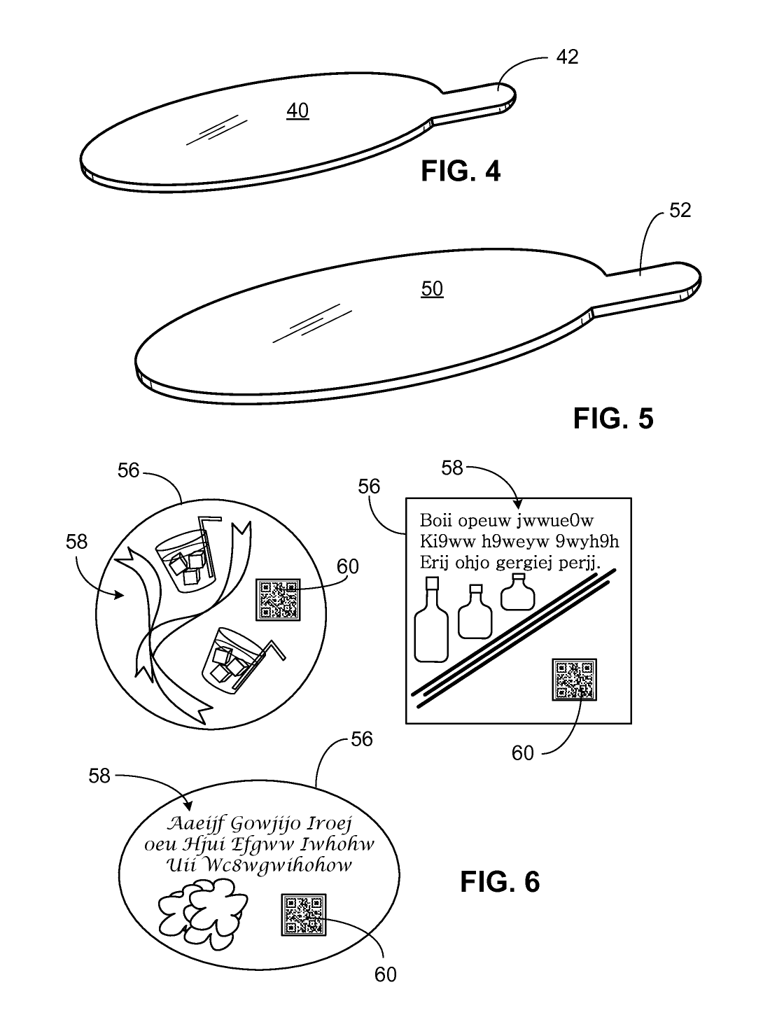

FIG. 5 is a perspective view of a top cover.

FIG. 6 shows top views of three examples of labels.

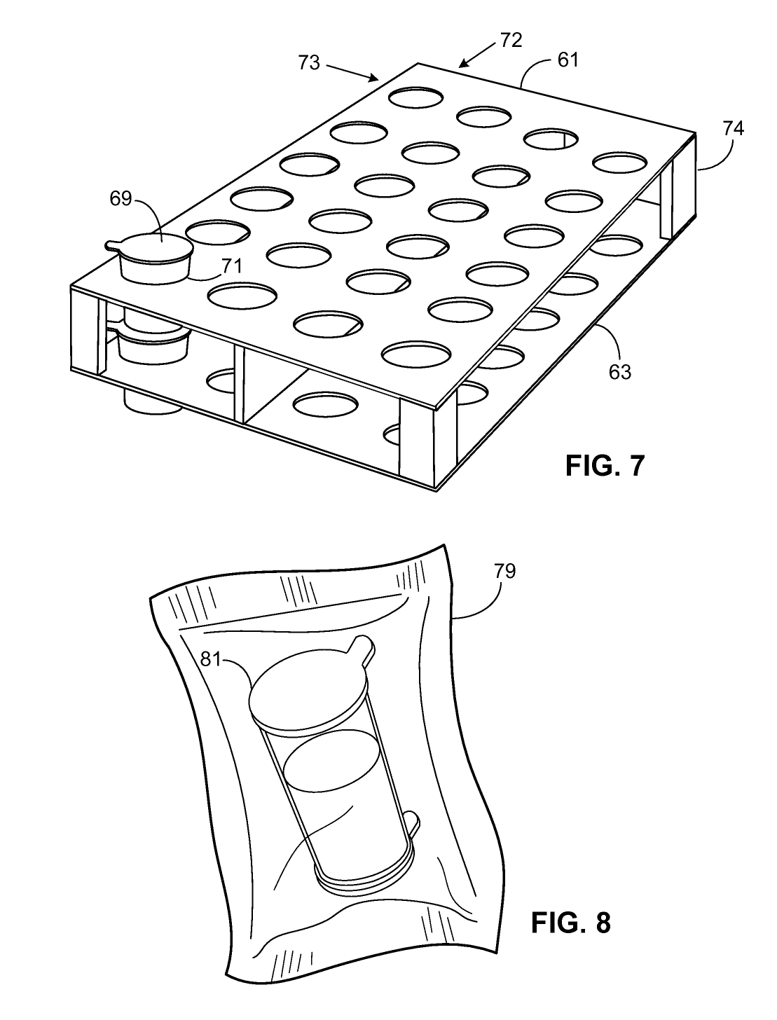

FIG. 7 is a perspective view of a tray and a container.

FIG. 8 is a side view of a package containing a delivery unit.

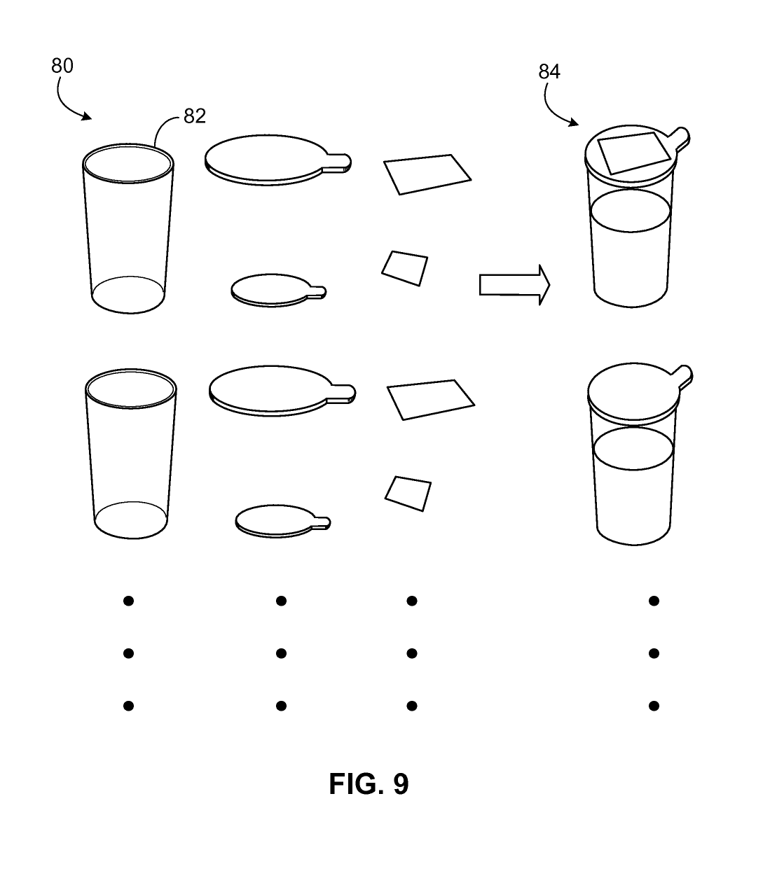

FIG. 9 is a schematic view of a kit and resulting delivery units.

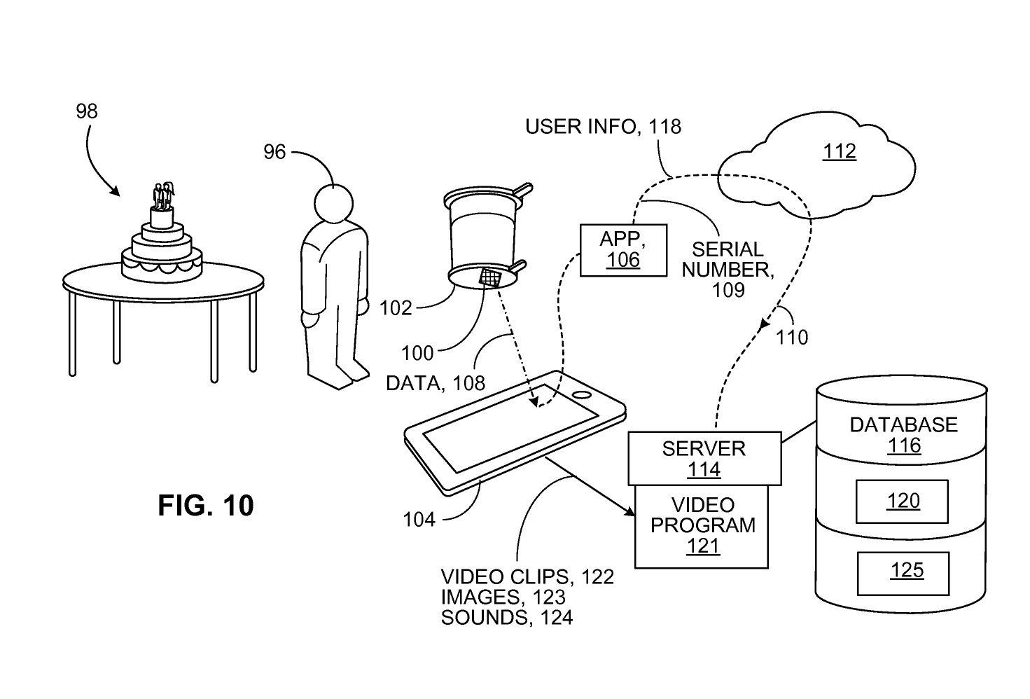

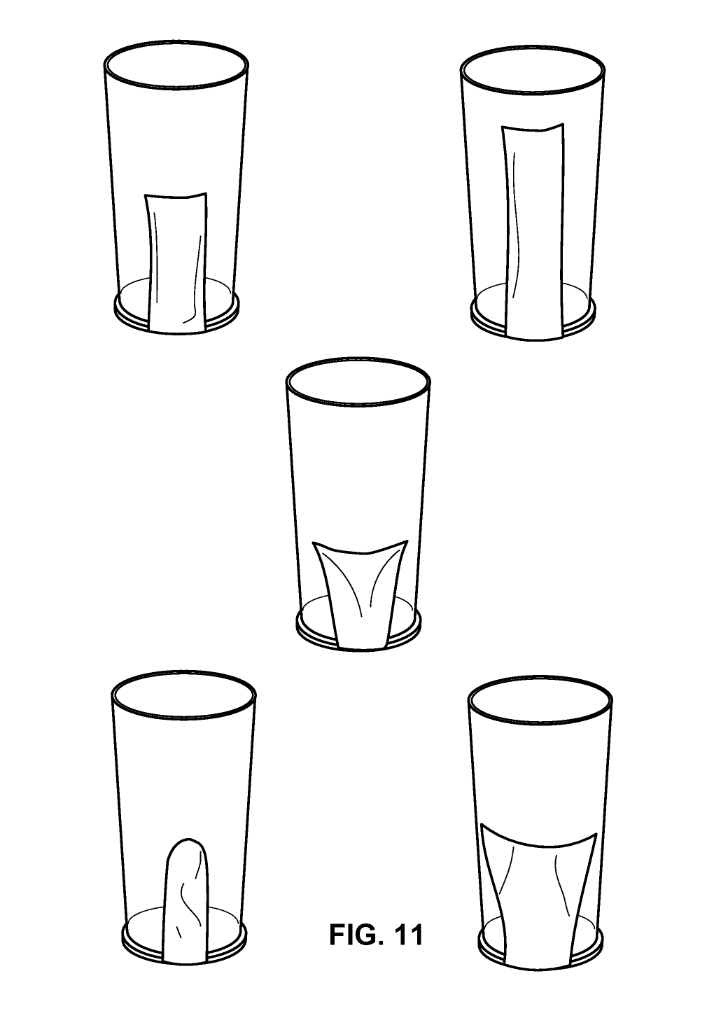

FIG. 10 is a block diagram of software and hardware.

FIG. 11 is a perspective view of containers bearing bottom covers with tabs.

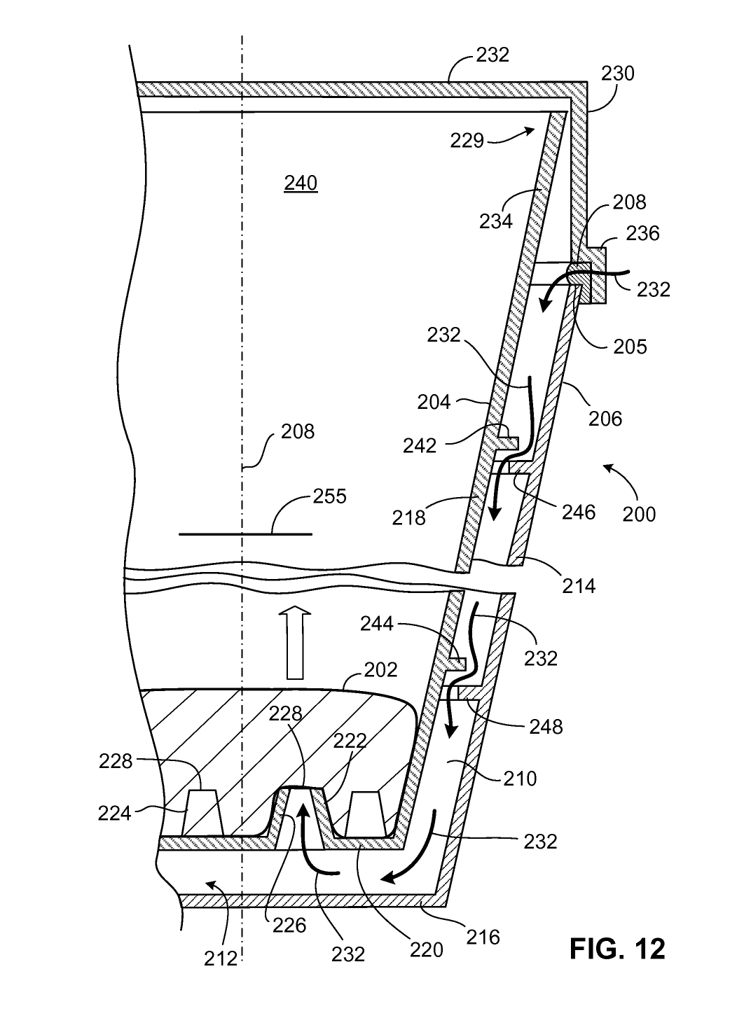

FIG. 12 is a side sectional view, partially cut away, of a container for a therapeutic agent.

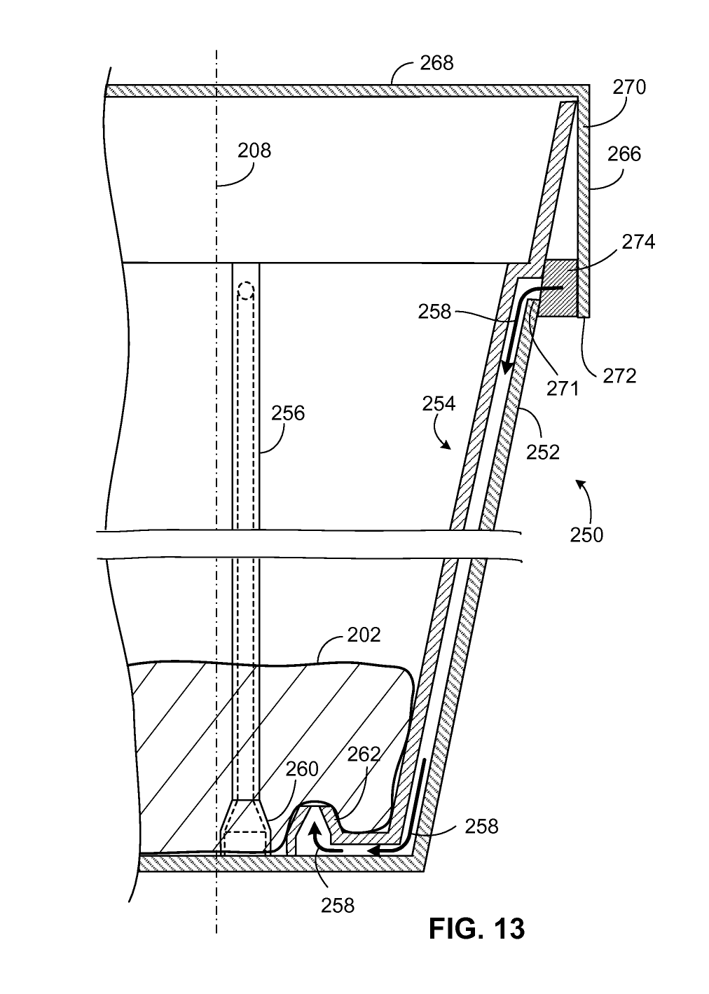

FIG. 13 is a side sectional view, partially cut away, of a container for a therapeutic agent.

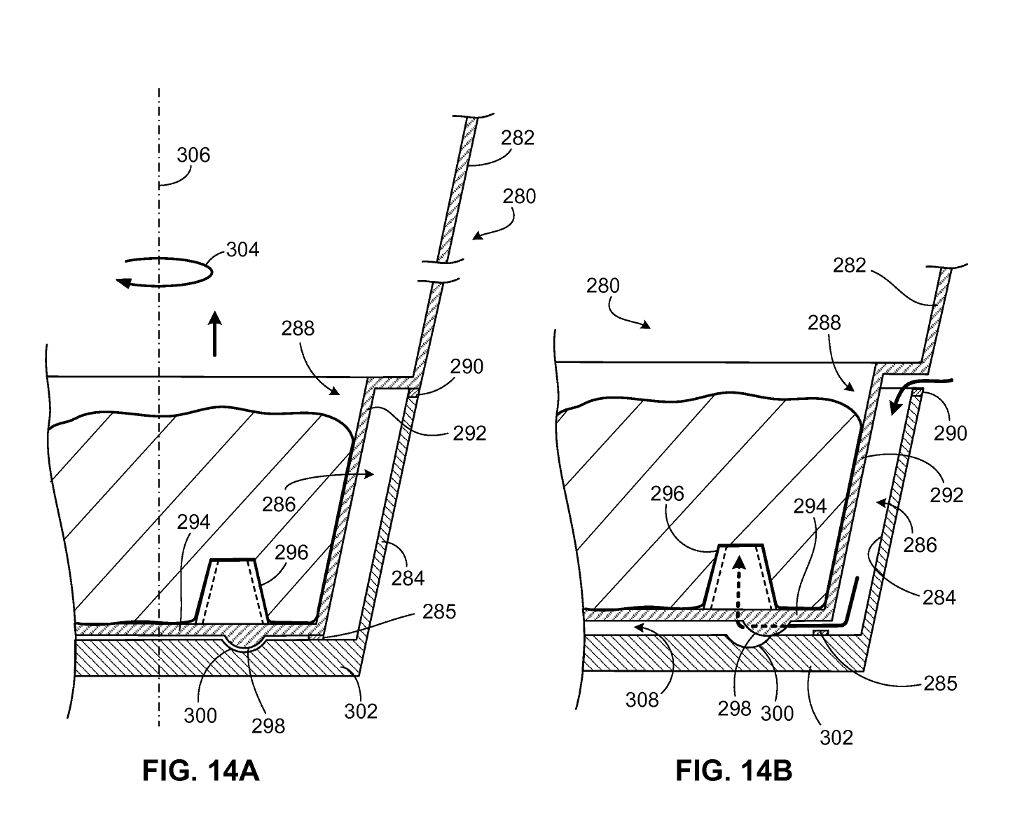

FIGS. 14A and 14B are side sectional views, partially cut away, of portions of a container for a therapeutic agent, shown in two different operational positions.

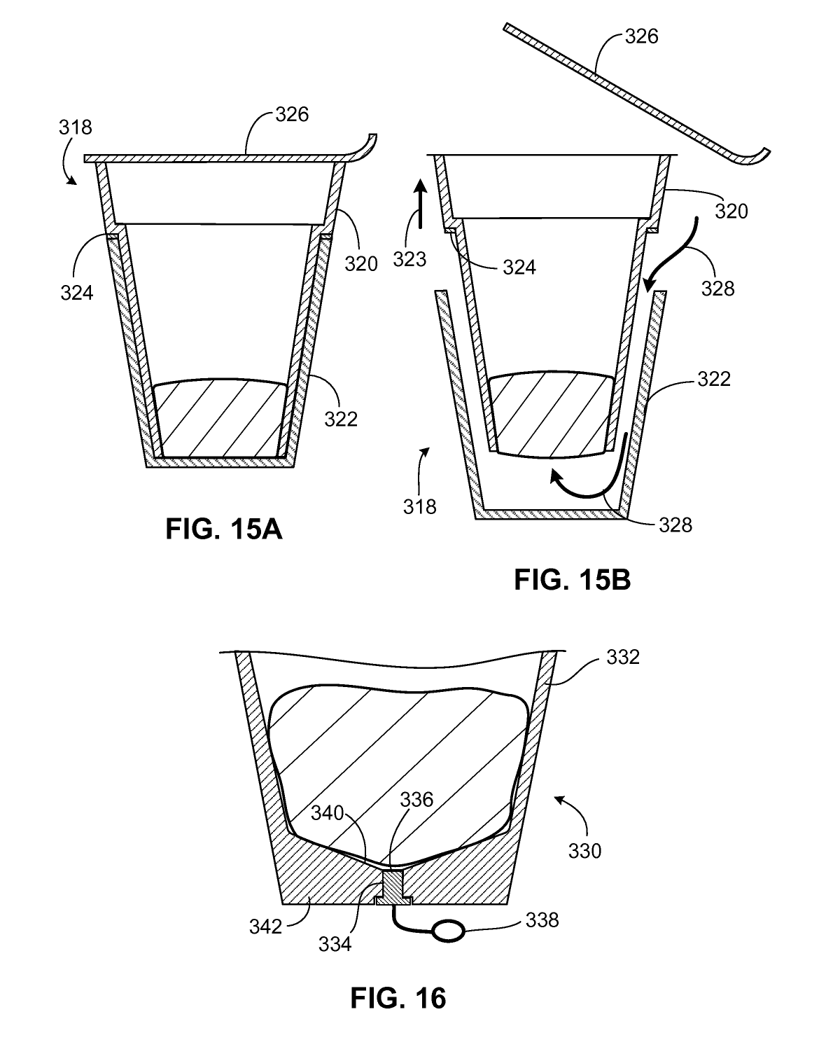

FIGS. 15A and 15B are side sectional views, partially cut away, of a container for a therapeutic agent.

FIG. 16 is a side sectional view of a portion of the container for a therapeutic agent.

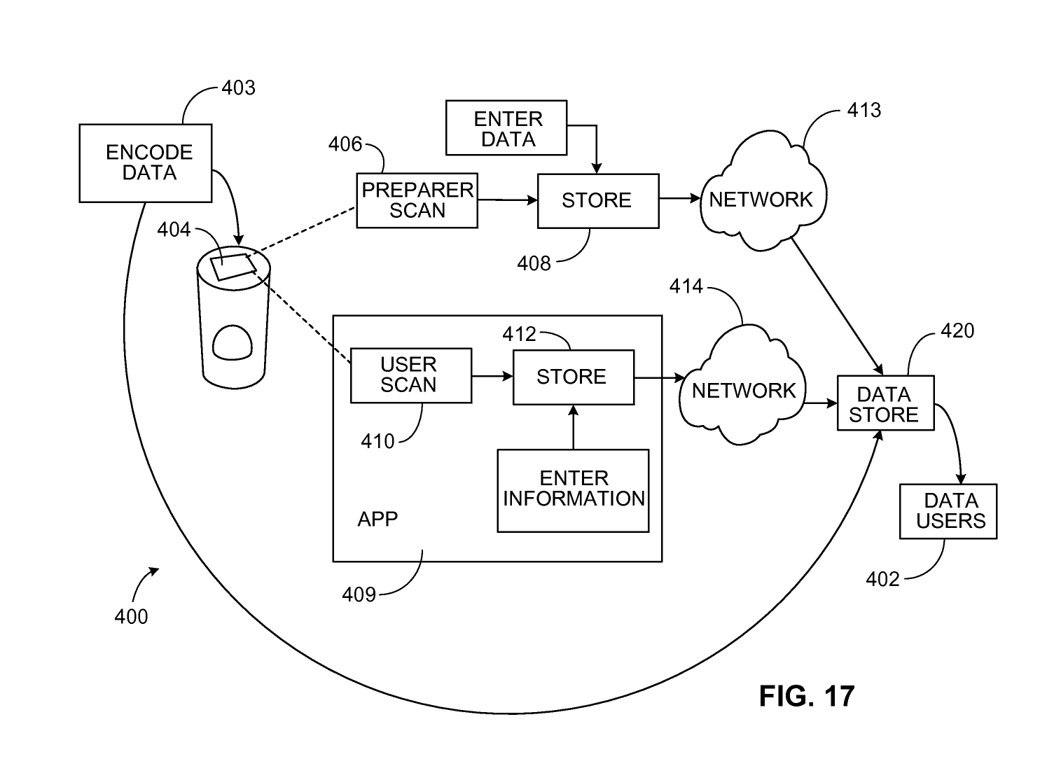

FIG. 17 is a schematic diagram of the use of containers.

Here, we describe devices and techniques for efficiently, easily, quickly, and without a mess passing quantities of shots of liquor or mixed drinks or doses of medicine, health supplements, energy drinks, or other therapeutic agents, from containers into people's mouths. When such a container has an opening in its bottom, a person can pop the gelled quantity of a therapeutic agent into his mouth in one step by sucking on the top of the container. The atmospheric pressure on the bottom of the quantity of a therapeutic agent then causes it to be released as a single mass from the inner wall of the container and to pop into his mouth. The sensation is fun and interesting, and there is no need to try to scoop the quantity of a therapeutic agent from the container using a finger or the tongue or a utensil.

In the following paragraphs we first describe examples of containers and techniques that enable a user to consume, for example, shots of liquor or mixed drinks or other drinks that have been formed as gelled blobs in the containers. Later, we describe some examples that are especially useful for delivery of therapeutic agents. The containers and techniques that we describe for the various examples may be useful in a wide range of applications and combinations of them and regardless of what is being consumed, for example, liquor, mixed drinks, or other drinks (which we together refer to sometimes simply as drinks), or medicine, health supplements, energy drinks, or other therapeutic agents, or combinations of them. In some cases, a therapeutic agent can include a drink or a drink can include a therapeutic agent.

Guests at a wedding reception, for example, can be served shot-glass style containers that contain gelled quantities of liquor. Or young children can take medicine by sucking on a cup (we sometimes use the word cup interchangeably with the word container) containing a gelled quantity of the medicine. A side variety of additional features and examples will be described below.

Implementations of the concepts that we describe here can include one or more examples of each of the following (and combinations of any two or more of them): a container, a quantity of a drink or a therapeutic agent, a bottom cover for the container, a top cover for the container, one or more labels, packaging, ingredients, kits, software, online facilities, analytics, and other elements and combinations of them. We sometimes refer to the container and quantity of a therapeutic agent or drink alone or with one or more of the bottom cover, the top cover, the labels, or the packaging a delivery unit. (We sometimes refer to therapeutic agents and drinks together is simply “consumables.”)

We use the term “quantity of a therapeutic agent” or “quantity of a drink” broadly to include, for example, any mass of material that is not a solid or a liquid and that can maintain its integrity under certain conditions such as room temperature; the quantity of a therapeutic agent or drink may, for instance, be gelled or congealed or thickened or stiffened or clotted or cohered, or a combination of them.

In some specific implementations of our concepts the quantity of a therapeutic agent or drink is a gelled shot of flavored liquor or alcohol, and the container is a small plastic shot-sized cup that has both an open top and an open bottom. The open top and the open bottom are each covered by a food-safe or medicine-safe peelable seal. A label in the form of a QR code is marked on the top cover or the bottom cover or both. Each or both of the labels can also bear other markings or information.

When both the bottom cover and the top cover have been removed, a user can easily pop all or part of the gelled shot as a single integrated quantity from the cup into his mouth by sucking on the top of the cup. By scanning the QR code using a smart phone, information about the shot can be fetched from the Internet or a connection can be made to online content for an event, say a wedding, at which the user has consumed the gelled shot. The QR code can also allow connection to, for example, a video production or other facility that the user can take advantage of in connection with the event or for other purposes. A tray that holds rows and columns of prefilled and sealed cups can be supplied by a manufacturer or a caterer and passed around to the guests at the wedding.

We use the term “container” broadly to include, for example, any vessel or receptacle that encloses a space where the quantity of a therapeutic agent or a drink can be held; the container may be, for instance, a cup, a bottle, a glass, or a vial.

In some cases, a container can be filled or partially filled with material to form one or more gelled quantities of a therapeutic agent or drink and the containers sealed and distributed by a manufacturer in large quantities of a therapeutic agent, for example, a liquor or pharmaceutical maker. In some cases, the containers can be filled by a distributor or wholesaler or by a consumer in small quantities of a therapeutic agent or a drink for personal or local use. The gelled quantities of a therapeutic agent or a drink can be formed using combined dry ingredients that are to be mixed with liquid to form a liquid base that can then be poured into the containers and gelled in place. Packages of combined dry ingredients can be supplied in large quantities of a therapeutic agent or a drink to manufacturers, wholesalers, or distributors, and in smaller quantities of a therapeutic agent or a drink to caterers, restaurants, pharmacies, and consumers. Kits that include containers, labels, and combined dry ingredients can be supplied to caterers, restaurants, pharmacies, and consumers for easy use.

We now describe particular examples of each of the elements of the devices.

Container

As shown in FIGS. 1, 2, and 3, in some instances, the container for the quantity of a therapeutic agent or a drink can be a simple tapered thin-walled round plastic cup 10 (e.g., a hollowed truncated cone) that is roughly the size and shape of a plain glass or plastic 1 ounce or 2 ounce shot glass that is open at both the top 11 and the bottom 13 of the cup. The plastic can be clear polystyrene or a wide variety of other plastics. The container (which we also sometimes call a body) can be made from a material that is intended for use in contact with food, such as any of the materials listed in FDA CFR Title 21-Part 177 or in any GRAS notice regarding material intended for use in contact with food.

The cup can be formed by molding. The wall 12 of the cup can be uniformly about 1 mm thick. The height 14 of the cup can be uniformly 60 mm. The capacity of the cup can be 35 ml of which 30 ml can be occupied by the quantity of a therapeutic agent or a drink.

The top 16 of the cup can be a simple round edge that defines the perimeter of the opening at the top of the cup and lies in a plane perpendicular to the vertical central axis 18 of the cup. The top 16 can have an outer diameter of 1¼ inches or 32 mm, for example. A removable label or cover 17 described later can be glued onto the top edge of the cup.

The bottom 20 of the cup can be a simple round edge that surrounds the opening at the bottom of the cup and lies in a plane perpendicular to the vertical central axis 18 of the cup. The bottom can have an integrally molded plastic circular rim or lip 22 that can project inwardly towards the vertical central axis 18 by a uniform distance of 2 mm, leaving a round opening in the bottom of the cup having a diameter of, for example, 20 mm. The total outside diameter of the bottom of the cup can be, for example, 26 mm. A removable label or cover 21 described later can be glued onto the rim or lip 22 across the bottom opening 13.

The inner surface 24 of the cup can be the untreated inner surface of the molded plastic or can be coated with a coating 26 selected to impart desired qualities to the inner surface. For example, the coating can be arranged to have an affinity for the quantity of a therapeutic agent or a drink in order to hold it in position within the cup until the quantity of a therapeutic agent or drink is sucked out, or, conversely, to be slippery to make it easier to suck the quantity of a therapeutic agent or drink out or a combination of the two.

A wide variety of other configurations, sizes, shapes, and materials and combinations of them can be used for the container. For example, the container could be metal, glass, plastic, rubber, silicone, wood, paper, cardboard, or any other material that is suitable for contact with the mouth or for containing an edible quantity of a drink or other food or a medicinal quantity of a therapeutic agent, or combinations of any two or more of them. The container could be formed of two or more layers, for example, a plastic inner layer and a paper outer layer, or any other combination. The container could be molded, machined, cast, extruded, stamped, wrapped, glued, cut, or formed in other ways or combinations of them. The container could be larger or smaller than the examples mentioned earlier, that is, taller or shorter, broader or narrower, or combinations of them. In some examples, the container could have other shapes than the tapered shape described earlier. The cross-section of the container could be other than round, for example, oval, or square, or free-form. The cross-section could vary with distance from the bottom of the container. The top and bottom of the cup need not be planar, but could have a wide variety of three dimensional profiles. The container could have two open ends that are not at the “top” and “bottom” of the container. One or the other of the ends or both of them could open on the sides of the container (when the bottom of the container is considered to be the side on which the container may be set down onto a surface, for example). The container need not have only a single chamber arranged along an axis but could have two or more chambers that connect to one another at an angle, for instance.

In some cases, it is useful for the top of the container to have a size, shape, and material that are suitable to put into the mouth and that enable a user to apply suction, e.g., to a space between the top edge of the container and the top of the quantity of a therapeutic agent or drink that are in the container. In some cases, it is useful for the shape and profile of the container to be arranged so that the cross-section of the container increases in size the smaller the distance from the top end or other suction opening. In this way when the user applies suction to the suction opening of the container, once the quantity of a therapeutic agent or a drink is released from the interior side wall of the container, the quantity of a therapeutic agent or a drink can pop suddenly in one mass from the container into the user's mouth. This provides a quick and easy way to transfer the quantity of a therapeutic agent or a drink from the container into the mouth and can be fun, unusual, and stimulating for the user, including for a child who is taking a quantity of a therapeutic agent or a guest at a party, for example.

In some cases, the inner wall of the container is annular and has a simple linear taper that opens out to the top end. The angle of the taper can be chosen to enable the quantity of a therapeutic agent to release easily from the inner wall and pop into the user's mouth. If the taper is too broad, the quantity of a therapeutic agent or a drink might not adhere sufficiently to the inner wall to keep it in place. If the taper makes the inner wall too nearly cylindrical, the quantity of a therapeutic agent or a drink may not easily release when the user sucks on the open end, or may require an unreasonable amount of suction to release the quantity of a therapeutic agent or a drink. In some implementations, a taper 23 of 12 degrees between the central axis 18 and the inner wall works well. In some examples, tapers in the range of 5 degrees to 15 degrees may also be particularly suitable. Nevertheless, almost any angle of taper may be used, without limit. For a typical shot glass size container having a diameter that fits well into an average mouth, and in order to provide a broad enough base at the bottom and for the container to sit stably on a surface, there may be a maximum possible angle of taper that can be achieved.

In some examples, the container need not be rigid, but could be semi-rigid or flexible or could be made of layers or sections having different degrees of rigidity.

In some implementations, it is useful for the container to have the size, shape, and material of an ordinary and familiar container such as a shot glass or a medicine bottle.

In some cases, one or two or more lines or other markings can be provided on the outside wall or inside wall or both of a container to indicate, for example, a filling height for one quantity of a therapeutic agent or a drink or two quantities of a therapeutic agent or a drink, or to indicate the level that represents the volume of water (say 75%) or the volume of alcohol (say 25%) that could be used to form the quantity of a therapeutic agent or a drink in the container. Other markings could also be provided.

Quantity of a Therapeutic Agent or a Drink

As shown in FIG. 1, in some implementations, the quantity of a therapeutic agent or a drink 30 can be a mass of a gelled drink such as an alcoholic beverage or mixed drink. The mass can contain alcohol, gelatin, flavoring, and other components of an alcoholic beverage. The quantity of a therapeutic agent or a drink can occupy part or all of the internal space of the cup 10 so that the bottom 32 of the quantity of a therapeutic agent or a drink is at the bottom of the cup and the top 34 of the quantity of a therapeutic agent or a drink is located at a height that leaves a space 36 between the top of the quantity of a therapeutic agent or a drink and the top of the cup. The space 36 can have a height of one cm for example, inches and may make it easier for the user to apply suction from his mouth to the quantity of a therapeutic agent or a drink to suck it into his mouth. There can be a space (not shown) between the bottom of the quantity of a therapeutic agent or a drink and the bottom edge of the container. There can be spaces above the quantity of a therapeutic agent or a drink and below the quantity of a therapeutic agent or a drink within the container or no spaces above or below the quantity of a therapeutic agent or a drink. In some implementations, by providing a space above and no space below, the quantity of a therapeutic agent or a drink can be made to look similar to a liquid material in the container.

A wide variety of compositions, ingredients, colors, decorations, stabilities, consistencies, and other characteristics may be imparted to the quantity of a therapeutic agent or a drink. In some cases, the quantity of a therapeutic agent or a drink can include gelatin or pectin or other thickeners or combinations of them to impart a gelled quality, rather than a liquid or solid quality, to the quantity of a therapeutic agent. In some instances, a quantity of a therapeutic agent or a drink that is gelled is flexible enough so that when suction is applied to the top of the container to reduce the pressure above or in the top space of the container, atmospheric pressure against a bottom surface of the quantity of a therapeutic agent or a drink is sufficient to push up on the quantity of a therapeutic agent and release it (e.g., suddenly) from the inner wall of the plastic cup, propelling it into the user's mouth as an integral connected mass. Ingredients of the quantity of a therapeutic agent or a drink can include emulsifiers, sweeteners, flavors, fragrances, medicines, and any other elements, constituents, ingredients or combinations of them that can be safely and beneficially sucked into the mouth or ingested into the stomach or both. The quantity of a therapeutic agent or a drink can be made to have any color or combination of colors that are possible with edible colorants and can include decorations of any kind that are edible, such as the kinds of decorations that are used on edible desserts.

Twelve different recipes for quantities of a therapeutic agent or a drink and instructions for mixing and using them are set forth in the following tables. The amounts required, for example, for one delivery unit (1-shot) and for 25 delivery units (25 shots) are shown in separate columns:

Recipe 1
Name vodka shots

| Ingredients | amount | units | 1 shot | 25 shots |
|---|---|---|---|---|
| jello powder - different taste | 85 | gram | 6.375 | 159.375 |
| water | 300 | cc | 22.5 | 562.5 |
| vodka | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | add Jello powder to boiled |
| | water |
| 2 | stirr |
| 3 | add vodka |
| 4 | stirr |
| 5 | fill glass |

Recipe 2
Name Daiquiri shots

| Ingredients | amount | units | 1 shot | 25 shots |
|---|---|---|---|---|
| strawberry jello powder | 85 | gram | 6.375 | 159.375 |
| water | 300 | cc | 22.5 | 562.5 |
| Rom | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | add Jello powder to boiled |
| | water |
| 2 | stirr |
| 3 | add rom |
| 4 | stirr |
| 5 | fill glass |

Recipe 3
Name Gin and Tonic

| Ingredients | amount | units | 1 shot | 25 shots |
|---|---|---|---|---|
| jello powder - different taste | 85 | gram | 6.375 | 159.375 |
| tonic water | 300 | cc | 22.5 | 562.5 |
| gin | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the tonic water untill |
| | there no bubbles |
| 2 | add the jello powder |
| 3 | stir |
| 4 | add gin |
| 5 | stir |
| 6 | fill glass as fast as possible |

Recipe 4
Name Blu Day

| Ingredients | amount | units | 1 shot | 25 shots |
|---|---|---|---|---|
| jello powder - different taste | 85 | gram | 6.375 | 159.375 |
| blu day | 300 | cc | 22.5 | 562.5 |
| vodka | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the blu day untill there |
| | no bubbles |
| 2 | add the jello powder |
| 3 | stir |
| 4 | add gin |
| 5 | stir |
| 6 | fill glass as fast as possible |

Recipe 5
Name mojito

| Ingredients | amount | units | 1 shot | 25 shots |
|---|---|---|---|---|
| jello powder - different taste | 85 | gram | 6.375 | 159.375 |
| ginger ale | 300 | cc | 22.5 | 562.5 |
| rom | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the ginger ale until |
| | there no bubbles |
| 2 | add the jello powder |
| 3 | stir |
| 4 | add gin |
| 5 | stir |
| 6 | fill glass as fast as possible |
| 7 | optional add a mint leaf |

Recipe 6
Name tequila

| Ingredients | amount | units | 1 shot | 25 shots |
|---|---|---|---|---|
| jello powder - different taste | 85 | gram | 6.375 | 159.375 |
| orange juice | 300 | cc | 22.5 | 562.5 |
| Tequila | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the orange juice |
| 2 | add the jello powder |
| 3 | stir |
| 4 | add Tequila |
| 5 | stir |
| 6 | fill glass as fast as possible |

Recipe 7
Name Lemon Drop

| Ingredients | amount | units | 1 shot | 25 shots |
|---|---|---|---|---|
| jello powder - different taste | 85 | gram | 6.375 | 159.375 |
| water | 200 | cc | 15 | 375 |
| Fresh Lemon | 100 | cc | 7.5 | 187.5 |
| vodka | 50 | cc | 3.75 | 93.75 |
| triple sec | 50 | cc | 3.75 | 93.75 |
| suger | 20 | gram | 1.5 | 37.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the water with the lemon juice |
| | and add the suger |
| 2 | add the jello powder |
| 3 | stir |
| 4 | add vodka and triple sec |
| 5 | stir |
| 6 | fill glass as fast as possible |

Recipe 8
Name Margarita

| Ingredients | amount | units | 1 shot | 25 shots |
|---|---|---|---|---|
| jello powder - different taste | 85 | gram | 6.375 | 159.375 |
| Fresh squeeze lime | 60 | cc | 4.5 | 112.5 |
| water | 240 | cc | 18 | 450 |
| Cointreau | 30 | cc | 2.25 | 56.25 |
| vodka | 70 | cc | 5.25 | 131.25 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the water with the lime juice |
| 2 | add the jello powder |
| 3 | stir |
| 4 | add vodka and Cointreau |
| 5 | stir |
| 6 | fill glass as fast as possible |

Recipe 9
Name Midori

| Ingredients | amount | units | 1 shot | 25 shots |
|---|---|---|---|---|
| jello powder - different taste | 85 | gram | 6.375 | 159.375 |
| Lemon juice | 300 | cc | 22.5 | 562.5 |
| Midori | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the lemon juice |
| 2 | add the jello powder |
| 3 | stir |
| 4 | add Midori |
| 5 | stir |
| 6 | fill glass as fast as possible |

Recipe 10
Name Vodka Red Bull

| Ingredients | amount | units | 1 shot | 25 shots |
|---|---|---|---|---|
| Jello powder - different taste | 85 | gram | 6.375 | 159.375 |
| Red Bull | 300 | cc | 22.5 | 562.5 |
| Vodka | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the red bull until there no |
| | bubbles |
| 2 | add the jello powder |
| 3 | stir |
| 4 | add Vodka |
| 5 | stir |
| 6 | fill glass as fast as possible |

Recipe 11
Name Pina Colada

| Ingredients | amount | units | 1 shot | 25 shots |
|---|---|---|---|---|
| jello powder - different taste | 85 | gram | 6.375 | 159.375 |
| Pineapple coconut juice | 300 | cc | 22.5 | 562.5 |
| Rom | 100 | cc | 7.5 | 187.5 |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the Pineapple coconut juice |
| 2 | add the jello powder |
| 3 | stir |
| 4 | add Rom |
| 5 | stir |
| 6 | fill glass as fast as possible |

Recipe 12
Name Coffee Shot

| Ingredients | amount | units | 1 shot | 25 shots |
|---|---|---|---|---|
| jello powder - different taste | 85 | gram | 6.375 | 159.375 |
| water | 300 | cc | 22.5 | 562.5 |
| Coffee (powder/grain) | 5 | gram | 7.5 | 187.5 |
| Coffee liqueur | 100 | cc | | |
| Vitamin B1 (Thiamine) | 5.31 | mg | | |
| vitamin B2 (Riboflavin) | 0.37 | mg | | |
| vitamin B3 (Niacin) | 9.55 | mg | | |
| vitamin b5 (pantothenic acid) | 1.55 | mg | | |
| vitamin b6 (pyridoxine) | 5.23 | mg | | |
| vitamin b12 (cyanocobalamin) | 8.72 | mcg | | |

Instructions:

| | |
|---|---|
| 1 | boil the water and add the Coffee |
| 2 | add the jello powder |
| 3 | stir |
| 4 | add Coffee liqueur |
| 5 | stir |
| 6 | fill glass as fast as possible |

In some cases, as shown, the formulas for the quantity of a therapeutic agent can include nutrients (e.g., vitamins) or other components that can reduce the intensity of a “hangover” yet remain below the amounts of such components that would require regulatory (such as FDA) approval.

In some implementations more than one quantity of a therapeutic agent or a drink could be included in the container. The quantities of a therapeutic agent or a drink included in the container could have the same or different ingredients, colors, decorations, consistencies, and stabilities, and combinations of them. When the user sucks on the top of the container, both quantities of a therapeutic agent could pop into his mouth.

Bottom Cover

The bottom, and the opening in the bottom, of the cup or the top and the opening in the top of the cup, or both, can be uncovered and unobstructed (either when the cup is loaded with the quantity of a therapeutic agent or afterward). However, as shown also in FIG. 4, in some examples, there can be a bottom cover or seal or lid 40 in the form of a flexible round seal having the same diameter as the outer diameter of the bottom of the cup. The bottom cover 40 can be attached to the bottom of the cup using an adhesive (such as an adhesive from the FDA list found at the following link: http://www.accessdata.fda.gov/scripts/cdrh/cfdocs/cfcfr/CFRSearch.cfm?CFRPart=175&showFR=1) that provides an airtight and liquid-tight seal of the bottom of the cup against the bottom end and associated rim of the cup, and allows the bottom cover to be peeled away from the bottom of the cup when the user is ready to suck the quantity of a therapeutic agent or a drink out of the cup. The bottom cover of the cup can have a flexible tab 42 that can be grasped and pulled by the user in order to peel the bottom cover away from the bottom of the cup. The bottom cover can be die cut from flexible aluminum foil that has a thickness ranging from extremely thin to, for example, 1 mm thick. Similar thicknesses could apply to the top cover. The bottom cover can be made from a material that is approved for use with foods and medicines. The bottom cover (and the top cover, described below) can be made of materials suitable for use in contact with food according to FDA CFR Title 21 Part 175 and part 177 or any GRAS notice. Aluminum foil can be used and attached to the body by direct heat.

The bottom cover can have any of a wide variety of shapes, sizes, materials, layers, markings, adhesives, and tabs. In some implementations, the bottom cover can be broader than the bottom of the cup to provide a more stable surface to support the cup, for example. The bottom cover can have a different shape than the bottom of the cup, for example, a square cover for a round bottom, or a round cover for a square bottom. The bottom cover need not be flexible or peelable and need not be attached by adhesive. In some cases, the bottom cover can be rigid or semi-rigid. In some implementations, the bottom cover can be attached by a slide coupling or a screw coupling or a hinge coupling to the bottom of the cup. Any approach to providing a bottom cover that is removable or reconfigurable to allow air to reach the bottom of the quantity of a therapeutic agent could be used. The bottom cover can be in the form of a breakable seal or alterable seal or puncturable seal so that the seal can remain on the bottom of the cup and an opening or pathway for air to reach the bottom of the quantity of a therapeutic agent can be formed by an action of the user such as pushing on or otherwise manipulating all or a portion of the bottom cover. Any arrangement that covers the bottom opening sufficiently to keep the quantity of a therapeutic agent in place and also allows for air to pass through to apply pressure to the bottom of the quantity of a therapeutic agent or a drink when the user sucks on the quantity of a therapeutic agent or a drink can be used, including arrangements that require the user to manipulate or otherwise act on the bottom cover.

The bottom cover can have a variety of features designed to enable the bottom cover to be peeled away or removed easily. These features can include a tab 42 which can have a variety of shapes, sizes, materials, and configurations. In some cases, the tab can be arranged to provide an indication that the cup has not been opened and therefore the quantity of a therapeutic agent or a drink has not been replaced or adulterated. For example, the tab can take the form of a long strip that extends from the bottom cover, is bent to extend along the side wall of the cup, and extends under the top cover, or is glued over the top cover. In such configurations, if the top cover has been removed and replaced, that fact may be apparent from the fact that the tab of the bottom cover has been tampered, removed, or broken. There can be two or more tabs that are features of the bottom cover and arranged in various ways. The tab or tabs can have materials, layers, or rigidities that differ from the main part of the bottom cover.

In some examples of the bottom cover (and of the top cover, described below) there need be no tab. The cover itself can be peeled or another device or mechanism can be provided to make it easy for the user to pull off the bottom cover or top cover or both.

Five different example configurations of tabs of the bottom cover are shown in FIG. 11.

In some cases, the bottom cover can be formed integrally with the cup or otherwise configured in such a way that the bottom cover or the cup or both can be manipulated (or simply respond to suction applied to the top of the cup) to form an opening (such as a slit or intersecting slits) for the ambient air to reach the bottom of the quantity of a therapeutic agent or a drink.

In some implementations, the bottom cover can include a slit or cross slits or other mechanism that enables the user to form an opening in the bottom cover that allows the ambient air to reach the bottom of the quantity of a therapeutic agent or a drink, so that removing the bottom cover is not necessary.

Top Cover

As shown also in FIG. 5, in some cases, the top cover 50 of the cup is a flexible round seal having the same diameter as the outer diameter of the top of the cup. The top cover can be attached to the top of the cup using an adhesive that provides an airtight and liquid tight seal of the top of the cup and allows the top cover to be peeled away from the top of the cup when the user is ready to suck the quantity of a therapeutic agent or a drink out of the cup. The top cover of the cup has a flexible tab 52 that can be grasped and pulled by the user in order to peel the top cover away from the top of the cup. The top cover can be die cut from flexible aluminum foil that is extremely thin to, for example, 1 mm thick. The top cover can be made from a material that is approved for use with foods and medicines.

The top cover can have any of a wide variety of shapes, sizes, materials, layers, markings, adhesives, and tabs. In some implementations, the top cover can be broader than the top of the cup to provide a broader area for marking, for example. The top cover can have a different shape than the top of the cup, for example, a square cover for a round top, or a round cover for a square top. The top cover need not be flexible or peelable and need not be attached by adhesive. In some cases, the top cover can be rigid or semi-rigid. In some implementations, the top cover can be attached by a slide coupling or a screw coupling or a hinge coupling to the top of the cup.

Any approach to providing a top cover that is removable or reconfigurable to allow the user to apply suction to the top of the quantity of a therapeutic agent or a drink or the space above it could be used. The top cover can be in the form of a breakable seal or alterable seal or puncturable seal so that the seal can remain on the top of the cup and so that an opening or pathway for suction to reach the top of the quantity of a therapeutic agent or a drink can be formed by an action of the user such as pushing on or otherwise manipulating all or a portion of the top cover. Any arrangement that covers the top opening sufficiently to keep the quantity of a therapeutic agent or a drink in place and also allows for suction to pass through to apply suction to the top of the quantity of a therapeutic agent or a drink or the space above it can be used, including arrangements that require the user to manipulate or otherwise act on the top cover.

The top cover can have a variety of features designed to enable the top cover to be peeled away or removed easily. These features can include a tab 41 which can have a variety of shapes, sizes, materials, and configurations. In some cases, the tab can be arranged to provide an indication that the cup has not been opened and therefore the quantity of a therapeutic agent or a drink has not been replaced or adulterated. For example, the tab can take the form of a long strip that extends from the top cover, is bent to extend along the side wall of the cup, and extends under the bottom cover, or is glued over the bottom cover. In such configurations, if the bottom cover has been removed and replaced, that fact may be apparent from the fact that the tab of the top cover has been tampered, removed, or broken. There can be two or more tabs that are features of the top cover and arranged in various ways. The tab or tabs can have materials, layers, or rigidities that differ from the main part of the top cover.

In some cases, the top cover can be formed integrally with the cup and configured in such a way that the top cover or the cup or both can be manipulated to form an opening (such as a slit or intersecting slits) for the ambient air to reach the top of the quantity of a therapeutic agent.

Sometimes, the top cover, the bottom cover, and the tab or tabs can be fabricated as a single integrated unit or a unit assembled from pieces. In use, the top or bottom cover of such a unit could be removed first and then the other cover, with the two covers remaining connected by the tab or tabs.

In some instances, it may be possible to make the container, both covers, and the tab as a single unit.

Among other things, using both the top cover in a bottom cover on the container conceal a container from ambient air so that the quantity of a therapeutic agent or a drink does not melt, disintegrate, or become dirty or contaminated, for example. Similar protection can be provided by enclosing a delivery unit in a sealed package, as discussed below.

Labels

Here we describe labels for the container, the top cover, the bottom cover, packaging, and other components. We use the term “label” broadly to include, for example, any thin device that can be attached to another component and bears information or codes; we also use the term to apply to any indicia that is marked on or formed on any of the components, for example, by printing, engraving, incising, branding, coloring, or any other technique.

As shown also in FIG. 6, in some implementations, one or more labels 56 can be attached to the bottom cover, the top cover, the inner surface or outer surface of the cup, or any of the other elements used to implement our concepts, including the packaging, software, ingredients, or kits. Each of the labels can include marked information 58 about the trade name, price, ingredients, method of use, warnings, online addresses, and nutritional information, or combinations of those and other kinds of information.

Each of the labels can include a machine-readable symbol 60, such as a QR code, that can be read by a scanner or a smart phone. The machine-readable symbol can encode data directly and can include data that represents references to other places (for example, online) where other data is stored. More information about the data is described below. The marked information 58 can be marked on the inside or the outside of the top cover or the bottom cover or on the inside or the outside of the cup. The marked information can be placed and arranged so that it can be easily scanned or read by a smart phone or other electronic reader.

The QR code and other coded data or other information on the labels can be unique to the delivery unit, or can be the same for and associated with all of the delivery units belonging to a group of delivery units, such as the units in a given multiple unit package, or the units distributed at a particular event, or the units containing a particular formula or production batch of a drink or a medicine.

In some cases, the QR code can be used by the app to direct the user immediately to a social networking site such as Facebook or Twitter or Google+ or to an email or texting app running on the mobile device. The user then can use such a site or app to tell others about the delivery unit, the quantity of a therapeutic agent or a drink, or the event, for example.

When the quantity of a therapeutic agent or a drink within the container contains alcohol (or another potentially risky material), the markings—on the labels, the covers, the containers, or other components—can provide indications of the degree of the risk associated with the alcohol based on the percentage of the quantity of a therapeutic agent or a drink that constitutes alcohol. For example, the top cover can be marked in color (or text or both) indicating the percentage of alcohol in the quantity of a therapeutic agent or a drink. For example, green could indicate 10% alcohol, yellow could indicate 20% alcohol, and red could indicate 30% alcohol. Typically, the quantity of a therapeutic agent would not contain more than 30% alcohol.

The labels can have a wide variety of shapes, sizes, colors, configurations, typography, design, content, and combinations of them. More than one label can be provided for a given delivery unit.

In some implementations, each label or the container or one of the covers can bear a mark or identification of a control number for purposes of quality control of medical dosages or of edible dosages.

Packaging

As shown in FIG. 7, in some cases, multiple delivery units 69 of the cup containing the quantity of a therapeutic agent or a drink can be packaged in compartments 71 arranged in rows 72 and columns 73 of a tray 74 for delivery at the place where the quantities of a therapeutic agent or a drink are to be consumed or for transporting from a place where the units are assembled to locations from which they are distributed. There can be five rows and five columns for 25 cups or two rows and five columns for 10 cups for example. The tray can have a top sheet 61 spaced above a bottom sheet 63, and round holes in the top sheet having diameters of, for example, 1 inch, can receive and hold the cups in place. In some implementations, the bottom sheet 63 can have similar round holes to hold additional units, and the vertical spacing of the two sheet 61 and 63 can be arranged to avoid interference between delivery units in the top sheet and delivery units held in the bottom sheet.

As shown in FIG. 8, in some implementations, in addition to packaging multiple delivery units of the cup as explained above, individual delivery units of the cup 81 containing the quantity of a therapeutic agent or a drink can be packaged (for example, in a sealed package 79) to protect the delivery unit, keep the delivery unit clean, and provide assurance to the user that no tampering of the delivery unit has happened. The packaging of an individual delivery unit can be in the form of a sealed wrapper.

Packaging for each delivery unit and for groups of delivery units can take a wide variety of shapes, forms, configurations, materials, sizes, colors, and other characteristics and combinations of them. Packaging can also be designed for multiples of individual components, such as containers or labels or covers or combinations of them.

Single delivery units, kits, and multiple delivery units, and other combinations of components can also be packaged without quantities of a therapeutic agent or a drink held in the cups, for later filling.

Kits

As shown in FIG. 9, in some implementations, a kit 80 can include components 82 useful or necessary to produce one or more delivery units 84. For each delivery unit, a kit could include a container, a top cover, a bottom cover, labels, dry ingredients to be dissolved to produce the precursor for a quantity of a therapeutic agent or a drink, and packaging, for example. Multiple units of each of the components could be provided to enable the user to make and package multiple assembled delivery units.

A wide variety of kits can be produced having a wide variety of components and multiples of components. Different kits can be produced that can be used together to fabricate one or more delivery units.

In some implementations, the containers in the can be supplied with bottom covers already attached to illuminate the step of requiring the user to attach a bottom cover before pouring liquid into the container.

Ingredients

In some implementations, packages 86 of pre-mixed dry ingredients to be mixed with liquor or other alcohol or water or other liquid can be provided for use in mixing volumes of liquid to be used in forming the quantities of a therapeutic agent or a drink. Once mixed, the volumes of liquid can be used in filling the cups, which can then be refrigerated or otherwise treated so that the liquid forms quantities of a therapeutic agent or a drink. The dry ingredients included in the package can be all of the ingredients necessary for the quantity of a therapeutic agent or a drink to be included in a finished delivery unit, including appropriate flavors, except for the liquid.

Pre-mixed dry ingredients can be provided in a variety of package sizes including packages that are small enough for a single finished delivery unit and packages that are large enough to produce a large number of finished units.

Manufacture

In some cases, manufacturing of the delivery units can proceed as follows. A liquid material that is the precursor to the quantity of a therapeutic agent or a drink can be formed by using a selection of ingredients that can include premixed dry ingredients, for example. In some cases, the ingredients can be liquid. When some of the ingredients are dry, liquid must be added to dissolve the ingredients. Liquid ingredients can include water or alcohol or fruit juice or combinations of them, for example. Dry ingredients can include sugar, salt, or powdered gelatin, or combinations of them, for example.

The precursor liquid material can be stored temporarily or over a long period of time or may be used immediately. When a cup or container is to be loaded with an appropriate amount of the precursor liquid material, a bottom cover or some other device for sealing the bottom of the container is first put into place so that when the precursor liquid material is poured into the container, it is held there. As noted earlier, in some cases the containers can be supplied with the bottom covers already glued on. The bottom cover can be the final bottom cover or could be a temporary bottom cover. The appropriate amount of precursor liquid material can vary widely. Suitable amounts could be 1 ounce, 2 ounces, or amounts in the range between ¼ ounce and 5 ounces, for example.

In some cases, a mixing vessel can be provided in which to mix and from which to fill a large number of containers. For example, the vessel could hold enough mixture dry ingredients and liquid for 25 finished delivery units. The vessel could be marked at appropriate levels corresponding to a volume of liquor or alcohol and a volume of water to be used in the mixing. For example, a marking on the vessel could indicate a level corresponding to 25% by volume of liquor or alcohol and 75% by volume of water. 25 portions of mixed dry ingredients could then be put in the vessel and the alcohol and water components added according to the markings.

After the precursor liquid material in this suitable amount has been loaded into the bottom each of the containers, a gelling action is applied. The gelling step could include refrigeration or simply the passage of time (say ten minutes or 30 minutes) in the case of a gelling agent that gels at room temperature without further intervention. The gelling agents and the manner in which they are triggered to gel the quantity of a therapeutic agent or a drink can vary widely and be based on a variety of chemical, mechanical, or thermal mechanisms.

Once the quantity of a therapeutic agent has been gelled, a top cover can be applied to seal the container, if the quantity of a therapeutic agent or a drink is not to be consumed promptly.

If labeling information is not already included on the top cover or the bottom cover, or even if it is, additional labels can be attached to the top cover, the bottom cover, or the container.

The finished delivery unit then can be packaged. In one level of packaging, a single delivery unit is wrapped in a sealed package for delivery to the consumer. In some implementations, two or more delivery units can be packaged together. In some cases, two or more delivery units can be placed in a tray for serving or delivery to one or more consumers. Then the tray can be packaged. Labels can be attached to the tray or the packaging of the tray or both.

The individual delivery units or groups of them can then be placed into the distribution channel to reach the consumer.

Fabrication of individual delivery units or groups of them can be done by private individuals for private use or for use at parties and events, by caterers, by bartenders, by distributors, by pharmacists, by wholesalers, or by original manufacturers. For example, a liquor manufacturer or a pharmaceutical manufacturer could produce prepackaged trays for distribution.

Software and Hardware

As shown in FIG. 10, in some examples, the user of a delivery unit can use a local mobile device or other mobile or stationary device; a program, a mobile app, or other computer software; a communication network; and digital storage either at a local device or at a central server to engage in activities related to the use of the delivery unit. Said another way, the use of the unit can be enhanced by software and hardware associated with the user or with the context in which the unit is to be used or both.

In some examples, a user 96 attending, say, a wedding reception 98 can scan the QR code 100 on the bottom cover 102 of one of the delivery units using a smart phone 104. An app 106 installed by the user and running on the smart phone can capture data 108 from the QR code. The data 108 can be unique to the particular delivery unit that bears the QR code, for example a unique serial number 109. The app running on the smart phone can send the unique serial number in a communication 110 over a cellular telephone network 112 to a central server 114 that maintains a database 116.

The app can send to the central server information about the user of the smart phone (assuming the user has entered information 118, say to register). Based on the unique serial number, the server can look up in the database information 120 that can include the manufacturer of the delivery unit, the date of manufacture, the name or title of the quantity of a therapeutic agent that is in the delivery unit (for example, the name of an alcoholic drink), the ingredients contained in the unit, an identification of the wedding reception for which the delivery unit was created, a wide variety of information associated with the wedding reception, or other information and combinations of information.

In addition, the server can add to the database information 125 about the user and the use of the delivery unit. For example, the server could add information about the user that the user had entered on her smart phone, such as her name, address, age, gender, and preferences, among other things. The server could also add information about the time of the communication, the identity of the smart phone, the location of the smart phone, or other information or combinations of information. The information contained in the database 116 can then be provided to and used by the user, the manufacturer, the distributor, the caterer, the smart phone user, other participants in the wedding (assuming their access to the information is permitted by the smart phone user), and others.

In some instances, the program, or the mobile app, or a browser running on the smart phone (or other mobile device) could engage the user in a game, an interaction with other users, an educational exercise, or another activity, or a combination of activities. Such an activity can have features that relate to the quantity of a therapeutic agent or a drink, the delivery unit, the user, or the event, or a combination of two or more of them.

A wide variety of such activities and features are possible.

In some implementations, a user of one of the delivery units could provide feedback about the quantity of a therapeutic agent or a drink. The feedback could be in the form of a satisfaction survey response or a much simpler format. One or more of the labels on the delivery unit could invite the user to provide feedback, perhaps with a legend of the kind that would read “please read our drink.” The feedback could be given electronically through the user's mobile device. For example, the user can scan the QR (or other) code on the delivery unit. An app running on the mobile device could then display a survey form. When the user completes the form, the mobile device could send the results to a server. In a very simple version, when the user scans the code, the mobile device could present a simple choice between a “thumbs-up” or “thumbs down” or between a “like” or “do not like” choice. In some cases the feedback could be in the form of a ranking. In addition, text feedback could be provided by the users.

The server can accumulate feedback data from a very large number of users and delivery units and could associate the feedback with information about the delivery units, such as the flavor, name, manufacturer, quantity of a therapeutic agent, ease-of-use, and any combination of those in a wide variety of other factors. The feedback data could also be associated with the demographic characteristics of the users. The feedback can be accumulated, aggregated, analyzed, and distributed to manufacturers, distributors, servers, and a wide variety of other parties.

Feedback and the resulting analytics of this kind could be very fine-grained and very accurate because it is provided at the moment at which the delivery unit is consumed.

More generally, this approach to accumulating user feedback could be applied to any kind of food or other product that is consumed by a user, for example, as a single consumable unit, in a context in which the user might be willing are interested in providing such feedback. Products of this kind could include canned or bottled beverages, candy bars, magazines, newspapers, cosmetics, and pharmaceuticals, for example.

In some implementations, for example, a guest at a wedding could be invited by a centrally running video editing and production program 121 to capture a video or a series of video clips 122 or images 123 or sounds 124 of the wedding reception and upload them to the central server. The program 121 could then automatically edit and combine the clips (along with other images, text, or video clips, for example, of the married couple) into a short edited video of the reception or other content presentation and return it immediately to the user at the reception and to other users (who have similarly registered through their mobile devices at the reception).

In some cases, two or more different users can provide clips, images, and text either independently or through a social networking medium for use by the program 121. The program 121 then could edit and combine content from different users either automatically or with the assistance of one or more of the users to produce finished presentations to be provided to one or more of the users. In this way, the social aspects experienced by participation in an event can be enhanced and translated into online social activities related to the event.

Because the program 121 can be aware of the user or users who have provided content items for inclusion in a presentation, the program 121 can insert items of content into a presentation that are not directly received from the user. Such items of content could include text, for example, a banner that reads “Congratulations and best wishes for a long and happy life. Nissim Shani.” In some cases, the program 121 could insert other items of content, such as a previously stored photograph of the user.

In some instances, a user could register through her mobile device with the server for a prize.

In some cases, when the quantity of a therapeutic agent or a drink contains a medicine, the user could learn information about the medicine or about a medical condition or about medical care providers by scanning the QR code and watching or listening to corresponding content returned from a central server.

Useful data 124 can be accumulated and stored in the database of the central server that ties coded identifiers (e.g., serial numbers) of delivery units with a wide variety of other information about the delivery units, events, users, and other contextual information. Such data can be aggregated and analyzed to produce statistical data that is useful for marketing, product formulation, and other purposes. For example, the statistical data could correlate the locations of use of a given flavor of quantity of a therapeutic agent or a drink with the frequency of consumption, or the times of the day when quantities of a therapeutic agent containing a particular medicine are ingested, or the elapsed time between the manufacture and use of delivery units by product.

Analytics

As discussed above, a wide variety of information can be accumulated about the delivery units, the users, and their uses. The information can include, for example, information that describes the delivery unit, information that describes the context of its use, information related to the user, information that describes the use, information related to marketing and distribution of delivery units, among other things. The information that describes the delivery unit can include the source, the manufacturer, the place of manufacture, the batch, control number, ingredients, formula, date of manufacture, expiration date, size, and other information. The information that describes the context of its use could include the identification of an event, the location, the type of event, the name of a restaurant or bar, or other information. The information related to the user can include name, age, address, contact information, association with the event or a host of the event, social network relationships with other users, and other information. The information that describes the use of the delivery unit can include the person who consumed it, the place of use, the time of use, and other information. The information about marketing and distribution delivery units can include information about promotions, advertising, unit volumes, geographic distribution, and other information.

A wide range of analytics can be applied to the information to generate analytical results. Among the things that can be analyzed are the demographics of people who use the distribution units; the locations, events, types of establishments, and times of consumption; the popularity of various formulations, products, ingredients, types of containers, types of packaging, and other aspects of the manufacture and distribution of the delivery units; and you and other results.

Other implementations are within the scope of the following claims.

In some cases, for example, it may be useful to configure the cups or containers so that they do not have broad bottom openings sealed by removable covers. Cups and containers that have sealed openings of that type can leave the quantity of therapeutic agent exposed if the cover is removed for any period of time before the therapeutic agent or drink is consumed. For example, suppose a nurse removed the bottom cover of a cup containing a gelled medicine and puts it on a tray before carrying the tray into a patient who is to consume the therapeutic agent or drink. Because the gelled medicine may then be exposed to in touch the surface of the tray, for example, the medicine may pick up bacteria or other contaminants.

In such cases, it may be useful to configure the bottom of the cup or container to reduce or minimize or eliminate opportunities for the therapeutic agent or drink to be contaminated before it is consumed. At the same time the cup or container should be configured so that the surrounding air can be allowed to reach the bottom of the therapeutic agent or drink immediately before consumption. The exposure of the bottom of the therapeutic agent or drink to the air immediately before consumption enables the user to suck or otherwise draw the therapeutic agent or drink into his mouth. The arrangements made to protect the therapeutic agent or drink from contamination until it is consumed while allowing air to reach the bottom of the therapeutic agent or drink at the moment of consumption may also provide a bottom surface that will support, for example, a therapeutic agent or drink that is to be gelled in the container between the time when it is poured into the container and the time when it is fully gelled. In some implementations, it may be possible to provide the bottom surface in one mode or configuration during the time when the therapeutic agent or drink is being gelled, and then to reconfigure the bottom into a different configuration from the time when the therapeutic agent or drink is gelled until shortly before the moment of consumption, and then to reconfigure the bottom again for use at the moment of consumption.

In some implementations, then, it is useful to arrange the cup or container to be able to be in one state during the manufacture, second state between the time of manufacture and just before consumption of the therapeutic agent or drink, and in a third state at the time of consumption. In the first state, the bottom of the therapeutic agent or drink being gelled is supported; in the second state, exposure of the therapeutic agent or drink to surrounding contaminants is minimized or eliminated. In the third state, areas exposed to the bottom of the therapeutic agent or drink. A wide variety of mechanical and other structures and devices can be provided to permit these changes of state. In some cases, the first and second state or the second and third state can be combined, depending on the structure of the cup or container. In some cases it may be possible to combine all three states into one by the way the structure is arranged.

As shown in FIG. 12, for example, a container 200 for a gelled mass 202 of a measured dose of a therapeutic agent can be fabricated as two concentric generally truncated conical elements 204, 206, arranged to have their central axes lie on a common axis 208. FIG. 12 illustrates the configuration of the two concentric elements 204, 206 in a state in which the fabrication of the container 200 has been completed and the container can be delivered through a distribution chain to an ultimate user, for example, to a patient to whom the measured dose of the therapeutic agent is to be administered.

As shown in FIG. 12, the inner conical element 204 has a smaller cross-section than the outer conical element 206, and also is shorter than the outer conical element 206. As a result an annular air space 210 and a flat bottom air space 212 are formed between the two conical elements. In manufacturing the container 200, the inner conical element 204 and the outer conical element 206 are mounted to be held apart to form the air spaces 210 and 212.

The outer conical element 206 has an outer conical wall 214 connected to a flat bottom wall 216. The inner conical element 204 also has an outer conical wall 218 and a generally flat bottom wall 220. The flat bottom wall 220 is punctuated by a pattern of upwardly directed truncated conical air vents 222, 224. Each of the conical air vents 222 has a conical side wall 226 that rises to an opening 228. The gelled dose 202 of the therapeutic agent or drink has been formed as a gel in the bottom of the inner conical element 204 conforming to the outer surfaces of the truncated conical walls of the air vents, as shown. In some implementations, the mass of a measured dose of the therapeutic agent may be into a semi-gelled state and then “poured” into the inner element 204 where it is then put into a final gelled state. The conical air vents 222, 224 may enable the measured dose to be changed from the semi-gelled state into the final gelled state within the inner element 204 without any of the dose leaking through the openings 228 to the outside world. In this respect, the conical vents may work better than simple holes formed in the bottom wall 220. In some implementations, simple holes could be used instead of or in addition to the conical vents.

As shown in FIG. 12, the container 200 also has a cylindrical lid 230 including a flat top wall 232 that meets a cylindrical wall 234. The diameter of cylindrical wall 234 may be the same as the diameter of the upper edge 205 of the outer element 206. A lip 236 can be formed at the bottom of the cylindrical wall 234 to surround (in close proximity) the upper edge of the outer element 206. A seal 208 is formed between the lip 236 and the upper edge 205 of the outer element 206 to provide an airtight seal to prevent contaminants from entering the air space 210 between the time when the container is manufactured and the time when the dose is consumed. The lid 230 can be attached securely to the outer element 206 by adhesive or a locking mechanism to maintain the airtight seal until the dose is consumed. In some implementations, the airtight seal 208 is also an adhesive material and serves the additional function of securely attaching the lid to the outer element 206.

When the dose 202 is to be consumed, the lid 230 is released from the outer element 206 by, for example, pulling up on the lid or, perhaps more effectively, by simply twisting the lid 230 about the axis 208 relative to the outer element 206 to break the seal. Once the seal has been broken, air 232 can flow (as indicated by the arrows) through the air spaces 210, 212 to the openings 228 to touch the bottom of the gelled dose. The user can then put his lips around the upper portion 229 of the inner element 204, suck on the air 240 above the gelled dose causing it to pop into his mouth as discussed earlier.

In some cases, rims 242, 244 that project outward from the outer surface of the inner element 204 and rims 246, 248 that project inward from the inner surface of the outer element 206 can be arranged to permit air to pass easily, but to prevent the dose in liquid or semi-gelled form from passing up through the air space 210.

As a result, the container can be fabricated and distributed through the chain of distribution, the lid can be removed (for example, by a nurse), and the container can be delivered to a user ready for consumption without concern that the dose would become contaminated prior to consumption, even if the container were set down on a contaminated surface.

In some cases, as described above for other implementations, a marking 255 on the vessel could indicate a level corresponding to 25% by volume of a therapeutic agent and 75% by volume of dissolved gelatin.

As shown in FIG. 13, in some implementations, a container 250 could be formed as a single truncated conical element 252 that has several tubes or channels 254, 256 integrally formed to provide pathways for air 258 to reach the openings in conical air vents (one per channel, for example) 260, 262 below the gelled dose 264. In some cases, the container 250 can have a cylindrical lid 266 formed with a flat top surface 268 meeting a cylindrical wall 270. The bottom edge 272 of the cylindrical wall 270 can extend down below the upper edge 271 of the conical element 252 and an annular seal 274 can provide an airtight seal and an adhesive attachment of the lid to the container. The container of FIG. 13 can be manufactured and distributed and then used in a manner similar to the one described with respect to the container of FIG. 12.

A wide variety of approaches can be used to permit a sealed container containing the dose to be changed from a tightly sealed state (for delivery and distribution) to a state in which it is ready for consumption.

As shown in FIGS. 14A and 14B, for example, a container 280 can be formed of an upper truncated conical element 282 that mates with a lower truncated conical element 284. The upper element 282 can have a reduced diameter bottom portion 288 that lies within the lower element 284, leaving an annular conical air space 286. By means of an annular adhesive seal 290 the upper and lower elements 282, 284 can be sealed to prevent air and contaminants from reaching the air space 286 during shipment and distribution. (An additional annular seal 285 can also be provided.) The bottom portion 288 of the upper element 282 can be formed of an outer conical wall 292 and a flat bottom wall 294 in which a pattern of conical vents 296 (only one shown) can be formed. One or more nipples 298 can be formed on the bottom of bottom wall 294 to mate with corresponding dimples 300 formed in a bottom wall 302 of the lower element 284. The one or more dimples and one or more corresponding nipples can be arranged in a pattern that causes the upper element 282 to rise when the upper element 282 is twisted 304 about the vertical axis 306 relative to the lower element 284. Cooperating elements (not shown) on the outer wall of the bottom portion of the upper element 282 and the inner wall of the lower element 284 can be arranged to prevent the upper element from becoming completely disconnected from the lower element when the two are twisted relative to one another.

When the container is to be prepared for a user to consume the dose, the upper element is twisted relative to the lower element, which breaks in the seal 290 and causes an air space 308 to open at the bottom of the container to allow air 310 to reach the gelled dose in a manner similar to the one described earlier.

As shown in FIGS. 15A and 15B, in some cases a container 318 can be formed to have an upper, inner element 320 and a lower, outer element 322 that are sealed together by an annular adhesive seal 324, as shown. The upper, inner element 320 can have a peelable lid 326 similar to the ones described earlier, and an open bottom that exposes the bottom of the gelled dose. To prepare the container for use, the lid 326 can be peeled off the top, the upper, inner element 320 can be twisted and pulled upward 323 (or simply pulled upward 323) relative to the lower, outer element 322 and the lower, outer element can be held attached to the upper, inner element 320 (by a mechanism not shown) in the extended position. Air 328 can then reach the bottom of the dose.

As shown in FIG. 16, in some instances, a container 330 can have a single truncated conical element 332 and a small central hole 334 in the bottom with a plug 336 connected to a tab 338. An upper surface 340 of the bottom wall 342 of the element 332 is formed as a cone. In use, the tab is pulled to remove the bottom plug and air flows up through the hole 334 and up along the bottom surface of the cone to release the gelled dose.

A wide variety of other structures and techniques can be used to provide features in which a gelled dose can be formed in a container, the container can be sealed against contamination and distributed in the chain of distribution, the containers can then be prepared easily for use without risking contamination of the dose, and the dose can be consumed by sucking on the top of the container by the action of air that is (after preparation of the container) able to press on the dose.

As shown in FIG. 17, a wide variety of data entry and collection techniques and applications 400 of the collected data can be used with the containers that hold the doses of therapeutic agents or drinks, for a wide variety of purposes. As a result of the way the data can be collected from the manufacturers and distributors of the containers and the doses, from the parties preparing the containers for use by the users, and from the users themselves, combinations of information not previously available or not easily available can now be collected and made available to data users 402. The data users can use this data for analytical, marketing, manufacturing, distribution, and other purposes.

In some implementations, a code (such as a QR code) 404 can be applied by the manufacturer or distributor or preparer to one or more parts of the container or packaging for the container or to materials that accompany the container. The code can be encoded 403 by a manufacturer, distributor, or a preparer to contain coded information such as the date of manufacture, the identity of the manufacturer, the location of the manufacturer, the identity of the therapeutic agent or drink, the dosage of the therapeutic agent or drink, a serial number for the batch, a serial number for the particular dose, the manufacturing protocol, the identity of parties along the distribution chain including the ultimate purchaser (such as a hospital), and a wide variety of other information associated with the manufacture and distribution. In some instances, the code need not directly contain such information and could provide a pointer (such as a URL) to a place where such information could be found. The coded information can be decoded by any device that has access to the decoding algorithm. The coded information can be provided to and stored in a data store 420. In some cases, when a party other than the user is going to prepare the container for use, such as an employee of a healthcare provider, the code can be scanned 406 and stored 408. The scanning could be done by a wide variety of devices including smart phones and other handheld devices as well as scanners. Other information, such as the identity of the preparer, the identity of the person who will consume the dose, the date of preparation, the location of preparation, and a wide variety of other information can also be entered and stored, either automatically or manually. For example, a nurse preparing a container for a patient could scan the code and then enter the identity of the patient so that the patient can be associated with the dose to be delivered. Some or all of the information acquired at the time of preparation of the dose can be stored and delivered through the Internet or another communication network 413.

In some applications, the person who is consuming the dose (or a family member or friend, for example) can use an app 409 running on a smart phone or other mobile device to scan 410 and store 412 and then to read the coded information. This can be useful to confirm that the dose is correct for the person who is consuming the dose, for example, that the identity and dosage are correct. This enables such a person to second-guess a healthcare provider on the accuracy of what is being presented to a patient, for example. By such techniques, such a person can become a much more active participant in the provision of healthcare compared to present systems.

In some cases, the app can provide a wide range of opportunities for such a person to record useful other information about the dose, the circumstances of its use, and the person who consumed it. For example, a person can enter identification information about the person who consumed the dose including a name, age, gender, weight, height, and a wide variety of other “objective” information. The person can also enter identification information about the person to consume the dose that is not objective, such as how the person is feeling, how easy it was to take the dose using the container, how well the person liked the flavor of the dose, how the person felt after taking the dose, whether the dose seemed to help the condition for which it was intended. The person can also enter other information about the circumstances such as the location, the identity of the health care provider, the date, the time, the condition of the dose when presented for consumption, the room number, the condition of the person to whom the dose was presented, suggestions about improvements that could be made in the container, the dose, the labeling, the presentation, and other factors. The person could also provide an audio comment or a video clip or general text comments.

The app can store all of this information temporarily or for a longer period of time and can then pass the information through the network 414 to a data store 420 located at another facility. The information accumulated preparer as described earlier can also be sent through the network 416 to the data store 420. Although data store 420 is shown as a single box, it represents a wide variety of ways of storing the data. The data can be stored in a single location or in multiple locations and the data store 420 can represent a single database controlled by a single party or separate databases hosted by different parties.

In some applications, information can be provided through the app every time a dosage is presented for consumption. This enables a time sequence of data for a given person to be accumulated. In some cases, information can be provided through similar apps by a very large number of people who are consuming a very large number of doses of a variety of therapeutic agents or drinks. This large volume of statistical information can be accumulated at the data store and used for analysis and improvement of the manufacture, distribution, delivery, and consumption of the dosages. By correlating this information with information about the prognosis, treatment, and outcomes for the people who consumed the dosages, information not currently available, and that can be very powerful, can be accumulated and used.

At the data store, the information accumulated using the app, the information accumulated by the preparer of the dose can be matched based on the QR codes or user identification information or a combination of those and other correlating data items.

Analysis of the information stored in the data store can be used to provide information, guidance, suggestions, models, and other material. These items can be used to determine a wide variety of factors. For example, the manufacturer of the containers can determine whether design changes would be desirable. The manufacturer of the finished doses in the containers can determine the appeal, effectiveness, utility, and other aspects of the doses. Manufactures and developers of therapeutic agents or drinks can analyze the circumstances and effectiveness under which certain kinds of therapeutic agents or drinks and doses can be delivered and used. Healthcare providers can better understand how and how effectively therapeutic agent or drink can be delivered as doses in such containers. A very wide variety of other applications are possible.

Although the above discussion has often use the example that relate to the delivery of therapeutic agents or drinks and dosages to patients in hospitals, for example, the applications can extend a wide variety of other contexts, such as delivery of dosages by parents to children, self administration of doses by users, use of dosages of home or in other non-institutional situations, delivery of doses in underdeveloped countries, and others.

Other implementations are also within the scope of the following claims. In the claims and sometimes in other places, we use the term “a therapeutic agent” to include, for example, a drink or a combination of a drink and a therapeutic agent.

1. An apparatus comprising
a container having a chamber and an open end of the chamber that is configured to be small enough to fit within lips of an opened human mouth and to have the lips seal the open end against air passing into or from the chamber,
a gelled dose of a therapeutic agent in the chamber in contact with a wall of the chamber and held between the wall of the chamber and the open end, a cross section of the chamber where the gelled dose is held being smaller than a cross section of the open end of the chamber,
at least one hole in the wall for air to reach the gelled dose, and
a mechanism having a first state in which the mechanism provides a seal to prevent air and contaminants from reaching the gelled dose through the hole, the mechanism being manually actuatable to cause it to transition from the first state to a second state in which the gelled dose is exposed directly to the air or the air can reach the gelled dose by a path that extends from an inlet through a channel to the hole.

2. The apparatus of claim 1 in which
the channel is unconnected to a space within the chamber except through the hole in the wall.

3. The apparatus of claim 1 in which the mechanism comprises two elements of the container that are concentric.

4. The apparatus of claim 3 in which the-channel comprises an annular passage between the two concentric elements.

5. The apparatus of claim 3 in which the channel-comprises a tube adjacent to the chamber.

6. The apparatus of claim 1 in which the mechanism comprises a breakable seal.

7. The apparatus of claim 1 in which the mechanism comprises a lid that covers the open end of the container.

8. The apparatus of claim 1 in which the hole in the wall comprise a conical vent.

9. The apparatus of claim 2 in which the mechanism permits the two elements to be moved relative to one another when the user is ready to consume the gelled dose.

10. The apparatus of claim 9 in which the mechanism permits the two elements to be moved axially relative to one another when the user is ready to consume the gelled dose.

11. The apparatus of claim 1 in which the mechanism comprises a lid the removal of which permits air to reach the at least one hole in the wall.

12. (canceled)

13. The apparatus of claim 2 in which the mechanism comprises devices on the two elements of the container that cause the air passage to be opened when one of the elements of the container is twisted relative to the other element of the container.

14. A method comprising
enabling a person who is consuming a dose of a therapeutic agent that has been pre-marked by a manufacturer with a scannable code, to scan and store the code on a mobile device,
enabling the person to input information into the mobile device that relates to the dose, its use, or the person, or a combination of any two or more of them, and
causing information associated with the scanned code and the information input by the person to be transmitted through a communication network to a data store.
